(19) United States
(12) Patent Application Publication
(10) Pub. No.: US 2010/0052879 A1
(43) Pub. Date: Mar. 4, 2010

(54) Apparatus and Method for the Tactile Identification of Keys and Regions of a Touch-Responsive Device

(76) Inventor: Steven G. Nanos, Princeton Junction, NJ (US)

Correspondence Address: DIEHL SERVILLA LLC, 77 BRANT AVE, SUITE 210, CLARK, NJ, 07066, US

(21) Appl. No.: 12/201,200

(22) Filed: Aug. 29, 2008

(51) Int. Cl. G08B 6/00

(52) U.S. Cl. 340/407.2

(57) ABSTRACT

Methods and apparatus for providing feedback to a user as to the location of a finger or stylus on a touch-responsive device are described herein. Aspects are directed to removable tactile feedback labels for use on a surface of a touch-responsive device. Other aspects are directed to tactile feedback label kits including one or more labels on a packaged substrate with instructions for use. Further aspects are directed to removable tactile feedback label systems including a touch-responsive device.

### BACKGROUND OF THE INVENTION

This application generally relates to the field of touch-sensitive and touch responsive devices, such as touch screens, keyboards or keypads. More specifically, this application relates to means for providing tactile feedback as to the location of a finger on a touch-responsive device.

Touch screens currently have no means of providing feedback as to the location of a finger, or stylus, other than by visual inspection, prior to actually activating the device by pressing on the smooth surface. This can lead one to press the wrong part of the touch-screen, resulting in incorrect input. This may affect the intent of the user and wastes time by making it necessary for the user to repeat the actions. Touch responsive devices, such as cell phone, PDA or calculator keypads, or computer keyboards, also currently have no means for the user to customize the surfaces of the device keys or buttons in order to enhance feedback and non-visual use of the device

For example, the lack of “non line of sight feedback” requires you to look away from tasks, critical or otherwise, and often causes distractions. For example, it may be critical to avoid distractions when driving, watching children, assisting at an emergency site, or just simply seeing what is happening around (where you would otherwise be focused on your devices screen). Any distraction may critically impact you and/or others, such as, avoiding being hit by a car coming instead of getting run over. Time not spent looking at the screen could be the time required to take appropriate action, such as moving out of the way, yelling, getting up and stopping the other party(s) or otherwise act in such a way that the potential injury does not occur.

While we may frown on such distractions, we know that distractions do happen and the result of such a distraction may directly cause injury, or even death and potentially impact multiple lives, such as may be caused by a car crash. There are also many indirect costs that occur. An accident could cause someone to miss a critical meeting and lose a sale, or cause a company to lose an account or even, in the case of a doctor, may cause him to be late with the result that a patient, whom otherwise might have been treated in time and/or correctly due to said doctors special knowledge and or ability, was not.

An incorrect message (email or text, for example), if not edited or proofread correctly (and we all know that even in such a case where proofreading occurs, errors may not be seen) may say exactly the opposite of the intended message. For example, a text from a virtual standard keypad layout on a touch screen could easily confirm to someone (spouse or possibly broker) that they should “not” buy something, such as stock, when the intended message was exactly the opposite, where what was meant to be sent was that they should “now” buy the very same thing. “T” & “W” are located immediately next to each other on the standard one handed key layout.

Therefore, there exists a need for providing feedback to help a person determine where there finger rests on a touch responsive device.

### SUMMARY OF THE INVENTION

Embodiments of the invention are directed to enhanced functionality for keys, buttons, area selection for input and data entry on touch-responsive devices.

The use of “sense of touch” textured aids such as raised shapes, raised lines, roughened areas or other textures, can be employed so that it is easier to locate keys that otherwise have no difference in feel on present touch-responsive devices. In addition to raised, or roughened areas, it is also possible to provide selected areas that are depressed and/or smooth as well, thereby providing additional means to achieve tactile feedback. By definition, for the purpose of feedback, a raised area or shape is only considered raised when compared to an adjacent non-raised or depressed area, and vice versa. A rough area is only considered rough in comparison to adjacent smooth or rougher area

These “sense of touch” aids could also be built into a phone, or other touch-responsive device, or a touch screen itself (such as a rough area to denote and provide feedback as to the location of critical keys/buttons (virtual or otherwise) such as “clear” or “OK” on a cell phone. On a keypad or keyboard type device, the use of custom multi-textured aids could be used to provide and enhance feedback on any combination of keys as preferred by the designer or user. Additionally, these multi-textured aids could be added as part of a film that adheres to the screen or touch-sensitive device. The films, which may incorporate any combination of rough, raised, smooth or depressed areas and textures, may be designed to cover all, or just parts, of a touch screen or touch-responsive device. Additionally, the aids could be incorporated into the construction of screen protectors, or the screen protector portion of sheaths, skins or cases.

Additionally, very small “film type” pieces could be provided or custom designed for each device so that, when applied, these pieces would simply cover only the selected input area(s) chosen by the user, leaving the rest of the screen or touch-responsive device untouched. This film could be offered for sale/use, and applied, in various thicknesses, shapes and sizes. The touch aids could vary in dimensions, location or coverage of the device screen, buttons or keys, depending on preference thereby maximizing usability and effectiveness for the specific device as preferred by the device designer and/or device users.

Additionally, sheaths, skins or cases for mobile devices can be custom designed with these functionalities built in, or provided with a removable and re-applicable film to be applied over all or part of the screen area. For example, a leather cell phone cover with a film for covering the screen.

This functionality can also be added through the use of a spray coating that dries hard and rough and can be applied by the user directly to the keys, or screen areas of a touch-sensitive device, without damaging the keys or screen. This can be permanent, if so chosen by the user and can be added to if worn off, or can be of a type that can be cleaned off and reapplied as needed again without damaging the keys or screen. Custom masks could be designed such that only the selected area(s) receives the coating and the masks themselves can be designed such that different textures are available as may be preferred by the user.

Small film pieces could be applied to touch-screen surfaces or non-touch screen surfaces. Non-limiting examples include keys of a typical button type entry device, such as a cell phone, PDA, calculator or other device, to provide tactile feedback as to the location of buttons. For example, a transparent label could be applied to the number ‘1’ button, the clear button or a specific letter button on a traditional cell phone, PDA or calculator. This would allow the user to feel the button as well as see through the label to read the text on the button.

These functions can also be provided by incorporating visual and/or auditory clues as to the location of the user's finger or other input assisting devices, such as a stylus. These locating clues could be by means of sounds (beep(s) etc.—short, long, repeating, special sequence, etc.), vibrations (short, long, repeating, special sequence, etc., in a different manner to that when inputting data—such as two small vibes instead of one longer one) or, especially when the device is being used in a dark environment, having the screen flash on/off when the user's finger/stylus is located over the associated key area. Again, the number and type of vibration or flash could be setup with default options, and could be setup where the owner/operator chooses to activate this feature, or features. Customization options may also be available to allow a user to specifically select the keys/areas for this functionality and select the type/frequency etc. of the feedback.

For example, a device could be provided with a touch-responsive device or capable of differentiating between a finger that is selecting a key for input and one that is simply searching for a key. This could be accomplished through touch itself, or by sensing the pressure of a finger and stylus when the finger or stylus passes over the associated area. Furthermore, when the device is an input only type device (such as hard keys) or multi-function device (such as a touch screen), when the finger passes over the activated area, that is in selection/input mode, feedback can be generated. If touch is used, harder pressure would indicate that input of that key is required, while lighter pressure may indicate that one is simply searching for a key.

Aspects of the invention enhance the speed of data entry, improve the accuracy of data entry, allow for simpler one handed use of many devices and allow for improved multitasking.

A manufacturer may also use a similar tactile enhancement on certain other keys such as end, send, menu, etc. Manufacturers could also consider adding this functionality into touch screens themselves. Software can be added which allows the user to customize the functionality that recognizes a finger and, prior to pressing the key, emits a unique vibration, sound or visual clue, that would then provide feedback as to where your finger is located. This could be done for multiple keys at the manufacturers or users option with each key getting it's default or user selected method of feedback and choice of options within the general method (e.g., unique vibration, sound or visual cues).

Accordingly, one or more aspects of the invention are directed to removable tactile feedback labels for use on a surface of a touch-responsive device. The label comprises a film having a front side and a back side. The back side of the film is adapted to interact with the surface of the touch-responsive device. The front side of the film has a texture. The texture of some aspects includes at least one projection or depression. The texture of other aspects includes a plurality of textures. The film for these aspects is typically, though not necessarily, made of plastic. Non-limiting examples of suitable films include plastics, elastomers, polymers, silica-based materials, silanes, paper-based materials and combinations thereof. The film may include anti-glare coatings is desired.

In some aspects, the film and/or the texture can be transparent (including semi-transparent). The film of other aspects can also be colored. In other aspects, the back side of the film has an adhesive. The back side of the film may also have a removable cover over the adhesive. The label of further aspects adheres to the surface of a touch-responsive device by electrostatic interaction. The label of some aspects is a transparent film which does not interfere with the normal functioning of the touch-responsive device.

Various aspects of the invention also have a package which encloses the labels. The package may contain more than one label, where each label has either the same texture, a different texture, or a combination of the two.

Other aspects of the invention are directed to tactile feedback label kits for use in association with a touch-responsive device. The kits include a substrate, a plurality of labels attached to the substrate, a package containing the substrate and a sheet of directions. Each label has a front side and a back side. The front side of each label has an identifiable texture and the back side of each label is adapted to attach to a surface of a touch-responsive device. The sheet of directions describes the use of the labels. The labels of various aspects can transparent, plastic and/or releasably attached to the touch-responsive device.

Further aspects of the invention are directed to removable tactile feedback label systems. The systems include a touch-responsive device, a film and a texture. The film has a front side and a back side with the back side of the film in communication with a surface of the touch-responsive device. The front side of the film has a texture that is identifiable by a human finger. The film of various aspects is transparent. The touch-responsive device of some aspects is selected from the group consisting of telephones, cell phones, personal digital assistants, calculators, computers and automatic teller machines.

The touch-responsive device of specific aspects is a cell phone having a screen and buttons. The label of detailed aspects is affixed to the screen of the cell phone and/or a key of the cell phone.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows front views of textured labels/films in accordance with aspects of the invention;

FIG. 2 is a perspective view of a textured label/film according to aspects of the invention;

FIG. 3 is a perspective view of a multi-textured label/film according to an aspect of the invention;

FIG. 4 is perspective view of an inverse-textured label in accordance with aspects of the invention;

FIG. 5 shows a textured label kit in accordance with aspects of the invention;

FIG. 6 shows a front view of a touch-responsive device having a textured label/film thereon;

FIG. 7 shows a perspective view of a touch-responsive device with stylus and textured screen in accordance with aspects of the invention;

FIG. 8 shows a perspective view of a touch-responsive device per an aspect of the invention;

FIG. 9 shows a spray system with template for creating a textured feedback area on a touch-responsive device;

FIG. 10 shows a perspective view of a holder/protector for a touch-responsive device having a textured film;

FIG. 11 shows a schematic of a touch-responsive device with feedback system; and

FIG. 12 shows a flowchart of the functioning of a touch-responsive device with feedback system.

### DETAILED DESCRIPTION

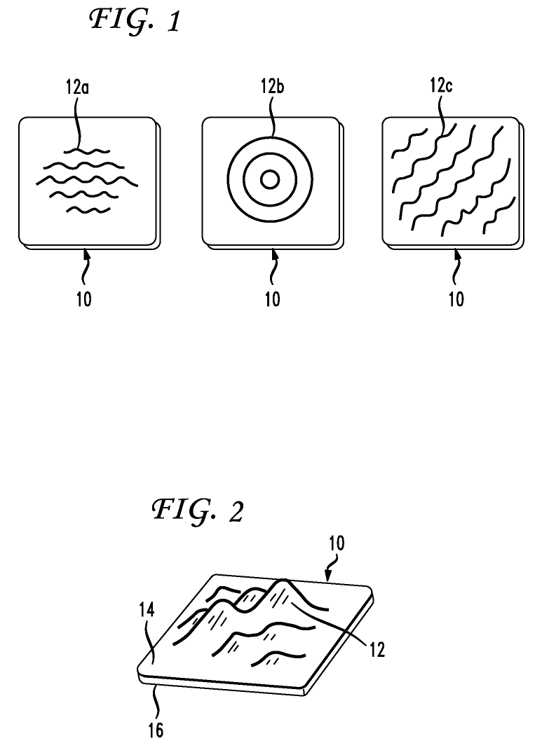

One or more embodiments of the invention are directed to removable tactile feedback labels for use on a surface of a touch-responsive device. FIG. 1 shows several removable tactile feedback labels in accordance with aspects of the present invention. The labels are a film 10 which have a texture 12a, 12b, 12c which can be felt or distinguished by a person. FIG. 2 shows a perspective view of a label or film 10 in accordance with aspects of the invention. The film 10 has a front side 14 and a back side 16 with a texture 12 on the front side 14. The thicknesses of the film 10 and relative size of the texture 12 are exaggerated for visual purposes. The back side 16 of the film 10 is adapted to interact with the surface of a touch-responsive device (not shown). The film 10 can be made of any suitable material. In detailed aspects of the invention the film 10 is made of plastic.

The back side 16 of the film 10 of some detailed aspects interacts with the touch-responsive device by use of an adhesive (not shown). The adhesive can be used to adhere the film 10 to a touch-responsive surface (i.e., a keyboard key) and provide assurance to the user that the film 10 will not move with use. Where the back side 16 of the film 10 has an adhesive, it is beneficial to have a removable cover over the back side 16 (see FIG. 5 below). The removable cover can be similar to the substrate to which standard labels are adhered prior to use. This allows the adhesive on the back side 16 of the film 10 to remain intact until needed. The adhesive may be releasable, allowing the film 10 to be easily removed.

In other detailed aspects, the film 10 adheres to the surface of the touch-responsive device by electrostatic interaction. This allows the film 10 to be placed on the device and easily removed/replaced if it gets worn out, or the user desires to change the location of the textures.

The film 10 of some aspects of the invention is transparent, allowing a user to place the film 10 with visible texture, or text, over an area of a touch-responsive device as desired by the user. In other aspects, the film 10 and the texture 12 are transparent, allowing the user to place the film 10 over existing indicia or on a screen with dynamic indicia (i.e., ATM machines and computer monitors) without obstructing the existing or dynamic indicia.

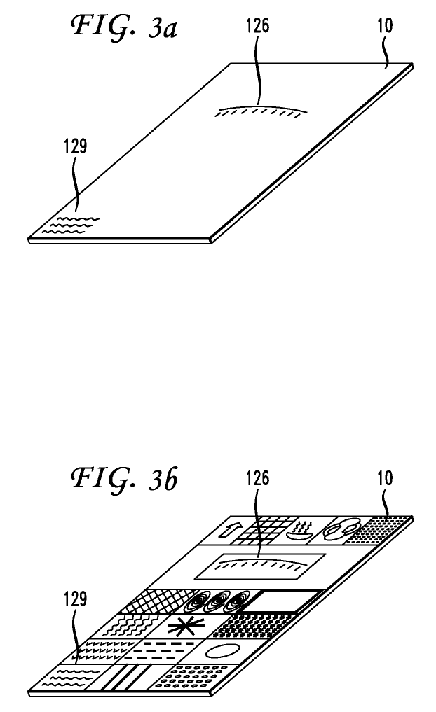

FIG. 3 shows a film 10 according to one or more aspects of the invention. The film 10 has two regions of texture 12a, 12b, but can have any number and type desired. The thickness of the film 10 is exaggerated for clarity. In use, this film 10 may be much thinner than 1 mm so as not to interfere with the operation of the touch-responsive device. The film 10 may be custom made for a specific touch-responsive device, for example an iPhone®. This would allow a manufacturer to produce the film 10 with a predetermined number and type of textures such as 12a, 12b, over specific areas of the screen which are commonly used.

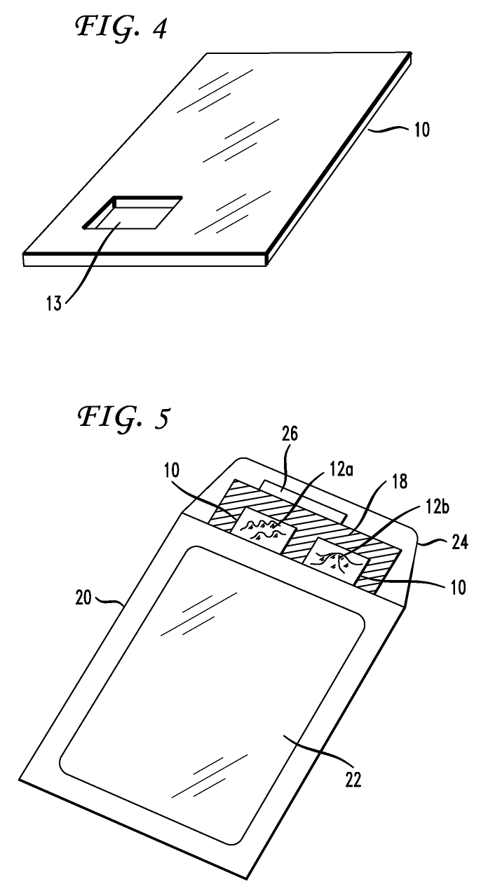

FIG. 4 shows a film 10 having a void 13 which can be applied to a touch-responsive device. The film 10 thickness is shown exaggerated for illustrative purposes. A user would be able to feel the difference in height between the film 10 and the void 13, thereby providing feedback as to the location of the user's finger or stylus. The film 10 may be textured which would serve to increase the difference in feel between the film 10 and the void 13.

Other aspects of the invention include films with adjacent multiple textured areas or voids. The film can be placed over the chosen key(s) area(s) directly or even on top of an installed screen protector. Different methods of tactile sensing could be used to differentiate different keys and then user installed as preferred. Users could be given multiple single or adjacent sized protectors with similar or different tactile methods and use them as desired to make it uniquely theirs in the way that is most personally effective.

Other embodiments of the invention are directed to tactile feedback label kits. FIG. 5 shows a plurality of labels 10 on a substrate 18 in a package 20 with an open flap 24. Each of the plurality of labels 10 has a front side with a texture 12a, 12b and a back side in communication with the substrate 18. The package 20 may have a transparent insert 22 thereby allowing the plurality of labels 10 to be observed from outside the package 20. The labels 10 can have different textures 12a, 12b, the same texture or can be a combination of different and similar textures. The sheet 18 can act as a removable cover for the back side of the labels 10 because the labels 10 are attached to the sheet 18 until the labels 10 are needed. A sheet of directions 26 which describe the use of the labels may be included with some aspects of the kit. The labels of some aspects are designed to be placed on a touch-responsive device without substantially interfering with the operation of the device. For example, a label may be placed on a touch-screen ATM machine over a specific area. The label can then provide feedback to a person, letting them know that their finger is over the region, allowing the user to apply pressure and select the region.

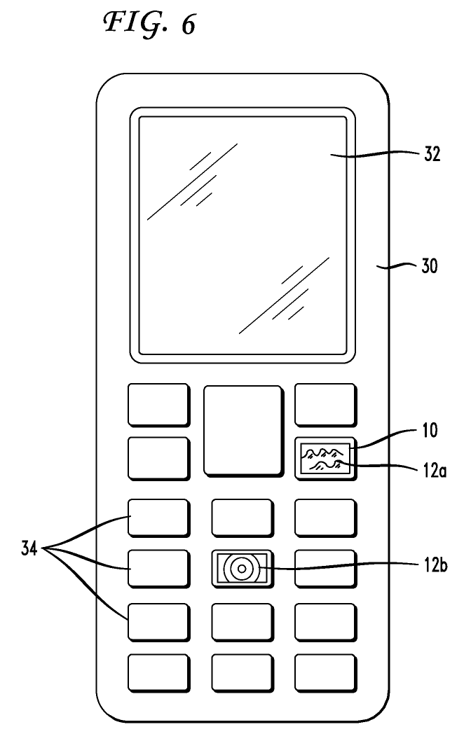

Additional embodiments of the invention are directed to removable tactile feedback label systems. FIG. 6 shows a touch-responsive device 30 (a cell phone) having a screen 32 and a plurality of buttons 34. A film 10 having a front side with a texture 12 and a back side is placed on a key on the touch-responsive device 30. The texture 12 on the front side of the film 10 is identifiable by a human finger. In some detailed aspects, the film 10 is transparent, allowing any indicia beneath the applied film 10 to be viewable.

In other detailed aspects, the touch-responsive device 30 is selected from the group consisting of telephones, cell phones, personal digital assistants, calculators and computers.

In a detailed aspect the touch-responsive device 30 is a cell phone with a screen and buttons, as shown in FIG. 6. In further detailed aspects of the invention, the film 10 is affixed to the screen 32 of the cell phone and/or a key 34 on the keypad of the cell phone.

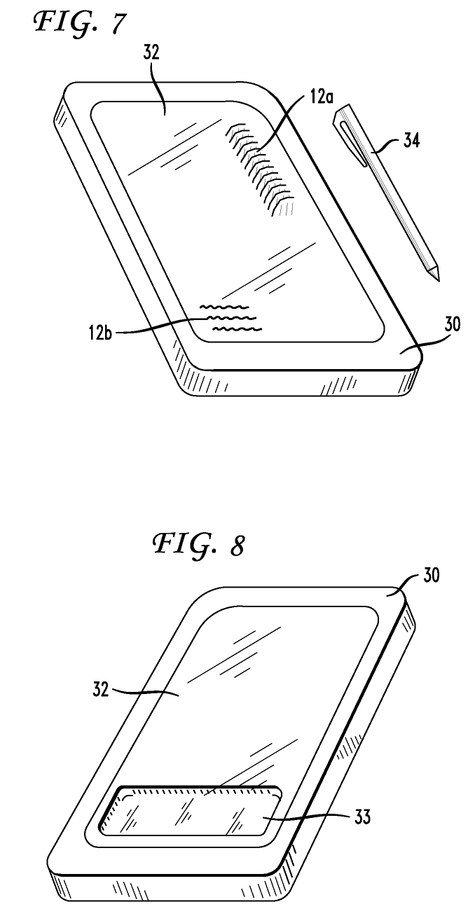

Further embodiments of the invention are directed to touch-responsive devices having a screen or buttons with textured surfaces. FIG. 7 shows a touch-responsive device 30 with a glass or plastic screen 32. The screen 32 may be manufactured with textured regions 12a, 12b. This would allow the manufacturer to sell devices, like an iPhone®, with a screen 32 which has frequently used areas texturized for easier identification. Many of these new electronic devices allow the user to control functions by moving a finger across the surface of the screen 32. By texturizing that area of the screen 32, the user is able to feel that they have placed their finger in the correct location on the screen 32.

FIG. 8 shows another aspect of the invention. A touch-responsive device 30 may have a screen 32 with a depression 33. The depression 33 could be located at a specific area of the device 30 depending on usage. For example, the depression 33 could be placed at a location used for scrolling. This allows the user to feel the area where the scroll bars are located without looking directly at the area.

The addition of tactile key locator clues (that work prior to actually selecting the key to input input's data or action into the device) could also be manufactured directly into the phone or device screen itself and could be standardized throughout the industry, or throughout a cell phone/PDA/Computer Screen/etc./product line, or even customized, by each manufacturer, for each device. This would likely be an effective route for a manufacturer during new phone rollouts or for a large installed model base.

In addition to aiding in location detection, the texture can be used to provide an increased degree of friction. This is especially helpful when a stylus 34 is being used to write on the screen 32 because it imitates the feel of writing with a pen or pencil on a piece of paper.

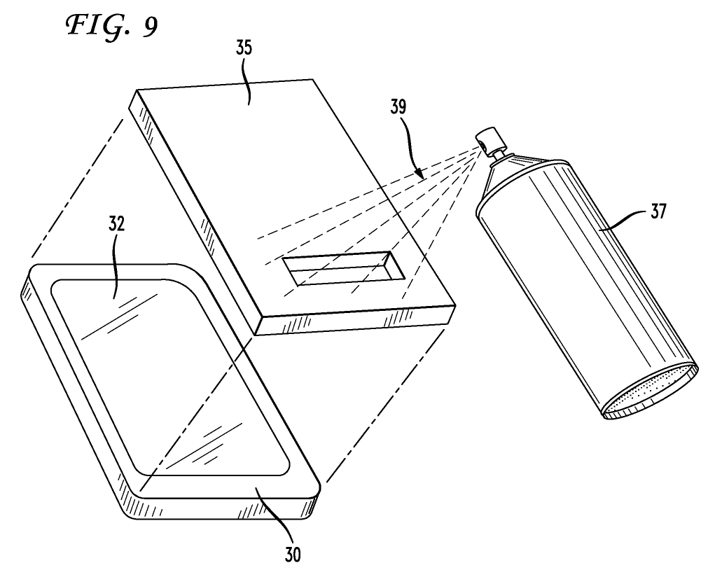

FIG. 9 shows a spray-texture system in accordance with one or more embodiment of the invention. A touch-responsive device 30 having a screen 32 is shown. A template 35 can be placed over the screen 32 to protect areas which are not to be textured. A spray can 37 can be employed to spray a flocculent 39 which dries on the screen 32 thereby providing a texture. The use of the template 35 allows the user to decide exactly where to locate the texture. The flocculent 39 can be permanent or removable. Additionally, as the flocculent 39 wears off, decreasing the feel of the texture, additional flocculent 39 can be added.

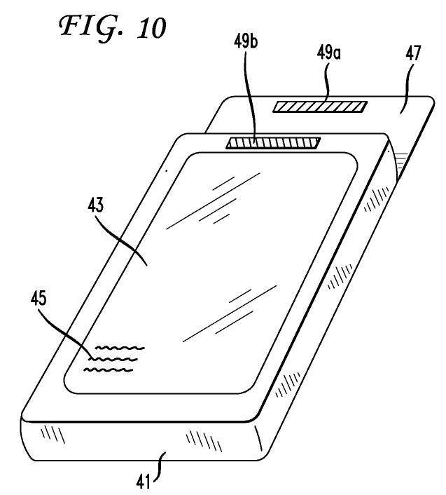

FIG. 10 shows a protective case 41 for a cell phone, or other portable electronic device. The case 41 may have a film 43 which could be glass or plastic. The film 41 can have textured portion 45 which can be customized for each device. The film 41 may be removable from the case 41 and replaced with a different film (not shown) having textures at different locations, or no texture. The case 41 shown has a flap 47 for securing the portable electronic device within the case 41. The flap 47 shown has an attachment means 49a which cooperatively interacts with a complementary attachment means 49b on the case 41. The attachment means 49a, 49b could be hook-and-loop, slot/tab, snap, magnetic or any other suitable attaching pair.

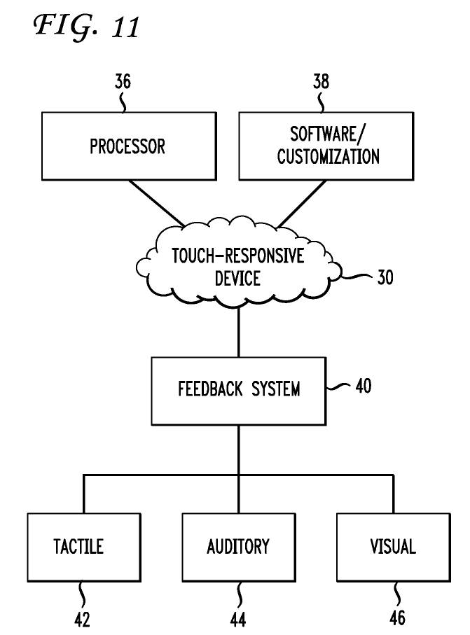

A schematic of touch-responsive devices of various aspects of the invention is shown in FIG. 11. The touch-responsive device 30 has a processor 36 which evaluates and data inputs and produces feedback 40. The processor may interact with software/firmware 38 which can allow the user to customize the feedback features. For example, the user may be able to turn on/off the feedback system, select the type of feedback 42, 44, 46 or set a threshold for contact with the device. The feedback 40 can be tactile 42, auditory 44 or visual 46, depending on the needs of the user. Tactile feedback 42 can be a slight vibration, the extent to which could be customizable, when the user touches a specified area of the screen or a key. Auditory feedback 44 can be a beep or tone that sounds when the user contacts the device 30 in specific, customizable, areas. The visual feedback could be, for example, a blinking light or flashing screen to indicate that the user has touched a specific area of the screen. All of these functions could be customizable, including the “hot spots” on the device using software/firmware 38. The terms “software” and “firmware” can be used interchangeably and neither is excluded.

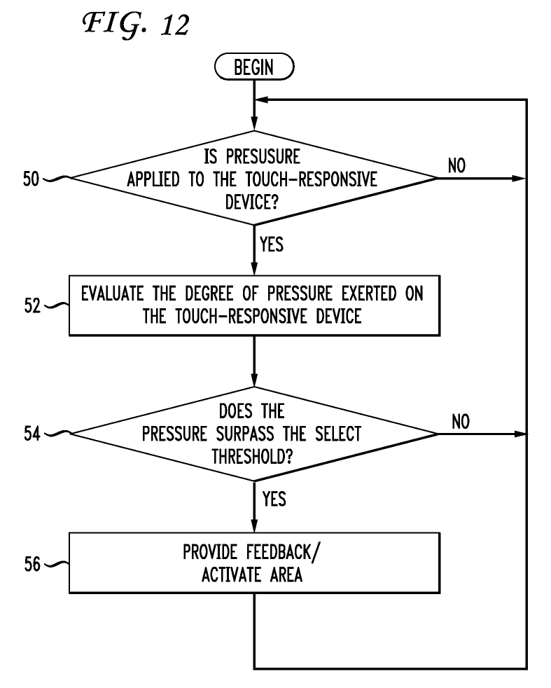

Other embodiments of the invention are directed to methods of providing feedback to a user. With reference to FIG. 12, a device may continually monitor whether pressure has been applied to a button or screen of the device. Additionally, application of pressure to the device may begin the flowchart shown on FIG. 12. The device evaluates whether pressure has been applied to the touch-responsive device 50. If no pressure is applied the device does nothing but continue to wait/monitor for pressure to be applied.

If pressure has been applied, the degree of pressure is evaluated 52. This may include evaluating whether pressure has been applied to a part of the device which is setup as a “hot spot” and if there is sufficient pressure applied. In step 54 the device determines if the pressure that has been applied is sufficient to consider the pressure an input. The device may be customized so that a light pressure may indicate that the user is searching for an area of the device. For example, a large screen may have a textured surface in the area of an electronic button. The user may be applying pressure to the surface of the device while searching for the textured area. This might commonly occur when the user is not looking at the device. The device could evaluate the pressure to determine if the user is searching for a spot or trying to activate an electronic button.

If it is determined that the user has intended to activate an electronic button, that is, the pressure has exceeded some predetermined threshold, then electronic button will be considered pressed. This will cause the device to activate whatever functions are associated with the “hot spot” that has been pressed.

### EXAMPLE

### Cell Phone

A cell phone has a “hot spot” associated with an electronic button that causes a cell phone to answer an incoming call. This button can be located on the screen of the phone or on a key, depending on the specifics of the phone. If the user is searching for the hot spot while driving, the cell phone may recognize the pressure as searching pressure. When the user places a finger over the hot spot, the phone generates feedback so that the user knows that they have touched the correct area of the phone. The user will exert slightly more pressure to that portion of the phone, thereby answering the incoming call.

The cell phone may provide feedback in several ways, all of which could be included and customizable from software on the phone. First, the feedback can be tactile using a textured surface either as a film attached to the device or built-into the device. Additionally, the tactile feedback can be a vibration which alerts the user that their finger is over the hot spot. Therefore, when the user slides their finger to the correct spot, the phone may vibrate slightly. Additionally, the strength of the vibration may be modified as the user finger nears the hot spot.

Secondly, the feedback may be provided as an auditory signal. When the user touches the hot spot, the phone may produce a beep or tone or play a recorded sound. For example, the user could touch the hot spot and the phone may play a sound of a person saying “Press to answer the call.” Additionally, the auditory signal could increase in intensity as the user approaches the hot spot. This would allow the user to tell how close they are to the correct location without looking at the phone.

Thirdly, the feedback could be visual. This may be accomplished by causing a light to flash or the screen to be illuminated when the user touches the hot spot. Additionally, the intensity of the flashing or illumination could be graduated to aid the user in identifying the proximity to the hot spot.

The user could exert pressure by either pressing harder on the hot spot or tapping the hot spot. The threshold for searching vs. activating and the pressure type (pressing or tapping) can be customizable for each device.

It may be advantageous to include software which trains the device in the user's specific touch. Like voice recognition software learns a person's voice by listening to a predetermined speech read by the user, the device may “listen” to the pressure exerted by the user during a predetermined setup routine.

Reference throughout this specification to “one embodiment,” “certain embodiments,” “one or more embodiments,” “an embodiment,” “one aspect,” “certain aspects,” “one or more embodiments” and “an aspect” means that a particular feature, structure, material, or characteristic described in connection with the embodiment is included in at least one embodiment of the invention. Thus, the appearances of the phrases such as “in one or more embodiments,” “in certain embodiments,” “in one embodiment,” “in an embodiment,” “according to one or more aspects,” “in an aspect,” etc., in various places throughout this specification are not necessarily referring to the same embodiment or aspect of the invention. Furthermore, the particular features, structures, materials, or characteristics may be combined in any suitable manner in one or more embodiments or aspects. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

As used in this specification and the appended claims, the singular forms “a”, “an” and “the” include plural referents unless the context clearly indicates otherwise. For example, reference to a “label” may also refer to more than one label, and the like.

As used in this specification and the appended claims, the term “touch-responsive device” refers to any device which responds to, or requires, user input generated by a finger, stylus, hand or other body part. Non-limiting examples of touch-responsive devices include keyboards, computer mice, keypads, cell phones, PDAs, household or office phones, touch-screens, ATM machines, television screens and calculators.

As used in this specification and the appended claims, the term “film” refers to any type of artificial membrane. Non-limiting examples of films include papers, plastics, silicas and skins. The term “label” and “film” are often used interchangeably in this specification, and should not be considered mutually exclusive.

As used in this specification and the appended claims, the term “texture” refers to any suitable texture that can be distinguished or felt by a human. It is well known that smooth surfaces (such as glass) are not completely flat but have surface variations on the microscopic level. However, these microscopic variations cannot be felt by a person, and are therefore outside the definition of texture as used herein. A texture can include projections, peaks, valleys, plateaus, points, bumps, waves, etc. as long as it can be felt by a person. Additionally, a texture can be smooth, where the adjacent regions are not smooth.

What is claimed is:

1. A removable tactile feedback label for use on a surface of a touch-responsive device, comprising:
a film having a front side and a back side, the back side of the film adapted to interact with the surface of the touch-responsive device; and
a texture on the front side of the film.

2. The removable tactile feedback label of claim 1, wherein the film is transparent.

3. The removable tactile feedback label of claim 1, wherein the film and the texture are transparent.

4. The removable tactile feedback label of claim 1, further comprising an adhesive on the back side of the film.

5. The removable tactile feedback label of claim 4, further comprising a removable cover on the back side of the film.

6. The removable tactile feedback label of claim 1, further comprising a package enclosing the removable tactile feedback label.

7. The removable tactile feedback label of claim 6, further comprising one or more additional removable tactile feedback labels in the package, each of the one or more additional removable tactile feedback labels having a different texture.

8. The removable tactile feedback label of claim 2, wherein the transparent film does not interfere with normal functioning of the touch-responsive device.

9. The removable tactile feedback label of claim 1, wherein the texture includes a projection.

10. The removable tactile feedback label of claim 1, wherein the film adheres to the touch-responsive device by electrostatic interaction.

11. The removable tactile feedback label of claim 1, wherein the texture is a plurality of textures.

12. A tactile feedback label kit for use in association with a touch-responsive device, comprising:
a substrate;
a plurality of labels attached to the substrate, each label having a front side and a back side, the front side of each label having an identifiable texture, the back side of each label being adapted to attach to a surface of the touch-responsive device;
a package containing the substrate; and
a sheet of directions describing use of the labels.

13. The tactile feedback kit of claim 12, wherein the labels are transparent.

14. The tactile feedback kit of claim 12, wherein the label can be releasably attached to the touch-responsive device.

15. A removable tactile feedback label system, comprising:
a touch-responsive device;
a film having a front side and a back side, the back side of the film in communication with a surface of the touch-responsive device; and
a texture identifiable by a human finger on the front side of the film.

16. The removable tactile feedback system of claim 15, wherein the touch-responsive device is selected from the group consisting of telephones, cell phones, personal digital assistants, calculators and computers.

17. The removable tactile feedback system of claim 15, wherein the film is transparent.

18. The removable tactile feedback system of claim 15, wherein the touch responsive device is a cell phone having a screen and buttons.

19. The removable tactile feedback system of claim 18, wherein the label is affixed to the screen of the cell phone.

20. The removable tactile feedback system of claim 18, wherein the label is affixed a key on the keypad of the cell phone.
